(19) United States
(12) Patent Application Publication
(10) Pub. No.: US 2007/0187159 A1
(43) Pub. Date: Aug. 16, 2007

(54) Power transmission apparatus for hybrid vehicle

(76) Inventors: Jang Moo Lee, Seongnam-si (KR); Namwook Kim, Seoul (KR); Youngmin Yoon, Seoul (KR); Seungbum Ha, Seoul (KR); Sung Tae Cho, Hwaseong-si (KR); Kukhyun Ahn, Seoul (KR); Horim Yang, Mokpo-si (KR); Beomsoo Kim, Seoul (KR); Byung Gil Lee, Gunpo-si (KR); Siu Yang, Seoul (KR); You Kwang Jeon, Sokcho-si (KR)

Correspondence Address: LADAS & PARRY LLP, 224 SOUTH MICHIGAN AVENUE, SUITE 1600, CHICAGO, IL, 60604, US

(21) Appl. No.: 11/354,782

(22) Filed: Feb. 15, 2006

(51) Int. Cl. B60K 1/00

(52) U.S. Cl. 180/65.2

(57) ABSTRACT

Disclosed is a power transmission for a hybrid vehicle which is capable of efficiently controlling energy generated from an engine to get a high degree of efficiency. A power transmission apparatus for a hybrid vehicle comprises an engine, a power splitting part using a planetary gear system, a generating part having two rotors generating electric energy through mutual influences and a motor generating driving force from the electric energy. The power transmission apparatus may reduce an amount of an energy transmitted from the engine to the generating part and also reduce an amount of an energy loss due to converting mechanical energy into electric energy in the generating part.

### BACKGROUND OF THE INVENTION

1. Field of the Invention

The present invention relates to a power transmission apparatus for a hybrid vehicle. More particularly, the present invention relates to a power transmission apparatus for a hybrid vehicle which efficiently controls the splitting of energy generated from an engine to improve the efficiency of the hybrid vehicle.

2. Descriptions of the Related Arts

Conventional vehicles usually employ internal-combustion engines, such as a gasoline engine, a diesel engine, a jet turbo engine and the like, and internal combustion engines generate a driving force by burning fuel. When the conventional vehicles need to decelerate due to a red light of a signal light or going downhill, they must reduce their speed by force using brakes and the energy generated from the internal combustion engine is wasted, as a state of heat energy, into the air. Actually, an internal combustion engine can convert only a portion of the total potential energy in fuel into kinetic energy, and a considerable portion of the kinetic energy may be wasted because of frequent stops and decelerations. Accordingly, the conventional vehicles are inefficient and which is one reason for a depletion of energy resources and environmental pollution.

Hybrid vehicles are being developed in order to make up for the above defects of the internal combustion engine, and some applications already are in common use these days.

Hybrid vehicles are usually comprised of an engine and an electric motor and are classified into a serial hybrid system, a parallel hybrid system and a serial/parallel hybrid system, according to power transmission methods. Particularly, in a serial hybrid system, the power of an engine is stored in a battery through a generator and the stored power in a state of electric energy is used to drive wheels via only a motor. In a parallel hybrid system, the power of an engine may be directly transmitted to drive wheels and indirectly transmitted via a motor installed parallel to the engine. In addition, in a serial/parallel hybrid system, a serial power transmission of the serial hybrid system and a parallel power transmission of the parallel hybrid system may be selectively or collectively employed.

FIG. 1 is a perspective view illustrating a conventional power transmission apparatus for a hybrid vehicle.

Referring to FIG. 1, a conventional hybrid vehicle of a serial/parallel hybrid system includes a gasoline engine 10, an electric motor 20, a generator 40, wheels 50, a battery 60 and a power control unit (not shown).

The hybrid vehicle has two driving parts serving as a power source. One is the gasoline engine 10, and the other is the electric motor 20. The electric motor may serve as a power source by operating with the generator 40, the battery 60 and the power control unit. The power control unit may include a high-voltage power circuit to increase the electric voltage supplied to the electric motor 20.

The generator 40 may include an AC/DC inverter, which can generate a high voltage of about 500 volt (V). The AC/DC inverter may convert DC (direct current) for the battery 60 and the motor 20 and AC (alternating current) for the generator 40. Occasionally, the AC/DC inverter may convert an alternating current generated from the motor into a direct current for the battery 60.

In addition, a power splitting device 30, which is an important element in a hybrid vehicle, can transmit mechanical energy from the gasoline engine 10, the electric motor 20 and the generator 40, and the power control unit can control the above elements connected to the power splitting device to ensure efficient operation.

FIG. 2 is a diagrammatic view illustrating a power transmission process in the conventional power transmission apparatus in FIG. 1;

Referring to FIG. 2, the power splitting device includes a planetary gear system 30, of which planet gear 32 are operatively engaged with a drive shaft of the gasoline engine 10 to rotate together with the drive shaft. The planetary gear system 30 further includes a sun gear 34 placed inside the planet gear 32 and a ring gear 35 outside the planet gear 32. The ring gear 35 is mechanically connected to the wheels 50 to transmit a portion of the energy generated from the gasoline engine 10 to the wheels 50. Namely, one portion of the energy of the gasoline engine 10 may be transmitted to the wheels 50 via the ring gear 35 and the other portion of the energy may be transmitted to the generator 40 via the sun gear 34. The electric motor 20 can provide a driving force independent from the gasoline engine 10.

However, in the conventional hybrid vehicle, large amount of the mechanical energy generated by the gasoline engine 10 may be transmitted to the generator 40 to be used for conversion to electric energy. Since the conversion from mechanical energy to electric energy is inefficient, the energy loss in the conventional hybrid vehicle may increase because of the conversion of the mechanical energy by the generator 40.

### SUMMARY OF THE INVENTION

The present invention provides a power transmission apparatus for a hybrid vehicle which can reduce a loss of energy occurring in a conventional energy conversion procedure.

The present invention provides a power transmission apparatus for a hybrid vehicle which can improve the efficiency of energy use by using a regenerative braking system which regenerates a portion of the energy expended when braking the vehicle.

The present invention provides a power transmission apparatus for a hybrid vehicle which can reduce an amount of fuel required to operate the hybrid vehicle, to help protect the environment.

According to an aspect of the present invention, a power transmission apparatus for a hybrid vehicle may comprise a first driving part; a power splitting part, an output part, a generator and a second driving part.

The hybrid vehicle usually uses two kinds of power sources, such as a gasoline engine and an electric motor, a hydrogen engine and a fuel cell, a gas engine and a gasoline engine, and a diesel engine and an electric motor. Recently, in order to substitute for fuel burning vehicles employing an internal combustion engine, electric vehicles have been increasingly developed. However, great inconveniences of an excessive recharging time and a high cost of recharging devices prevent electric vehicles from being commonly used. Therefore a new concept of vehicle becomes necessary, and, as a result, a hybrid vehicle is developed as a new counterproposal. Currently, the most popular hybrid vehicles sold in the car market employ a gasoline engine and an electric motor.

In the present embodiment, the power transmission apparatus may be applied in a hybrid vehicle. An energy generated by the first driving part (e.g. a gasoline engine) is divided into two or more branches of the energy, and more particularly, a branch of the energy is directly transmitted to the wheels through a mechanical connection, while another branch of the energy is indirectly transmitted through an electrical connection via a generator.

In reference to the first and second driving parts, there may be a gasoline engine, an electric motor, a fuel cell engine, a hydrogen engine, a gas engine, and a diesel engine, according to the definition of “hybrid vehicle.” In addition, the second driving part may be one selected from the above mentioned conventional engines, which is capable of generating a driving force using energy converted by the generator.

The power splitting part may split an energy generated from the first driving part into two or more branches of the energy, and one branch of the energy may be transmitted to the output part fully or partially. The generator may comprise a first converting section for converting another branch of the energy into one type of a storable energy and a second converting section for converting a portion of the one branch of the energy into another type of the storable energy. The first and second converting sections may generate the storable energy through mutual operations.

The power splitting part may comprise a sun gear, a planet gear and a ring gear, and the first driving part may be operatively connected to the planet gear of the power splitting part to supply the full energy to the planet gear. The generator may comprise an inner rotor operatively connected with the sun gear, an outer rotor operatively connected with the ring gear to rotate along the circumference of the inner rotor, and a stator disposed around the outer rotor. The inner rotor may serve as the first converting section and the outer rotor may serve as the second converting section.

The second driving part may drive the output part using an energy generated by the generator.

In the present aspect of the invention, the power splitting part splits the energy generated from the first driving part into two branches of the energy in order to send the two branches to the output part and the generator respectively. Otherwise, in another aspect of the invention, a power splitting part may split the energy generated from a first driving part into three or more branches of the energy. In this case, one branch of the energy may be supplied directly to an output part and the other branches of the energy may be supplied to a generator to be converted into storable energy respectively.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a perspective view illustrating a conventional power transmission apparatus for a hybrid vehicle;

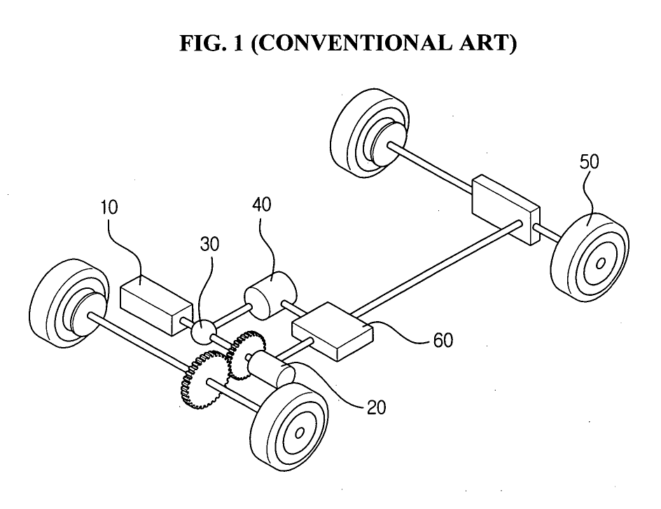

FIG. 2 is a diagrammatic view illustrating a power transmission process in the conventional power transmission apparatus in FIG. 1;

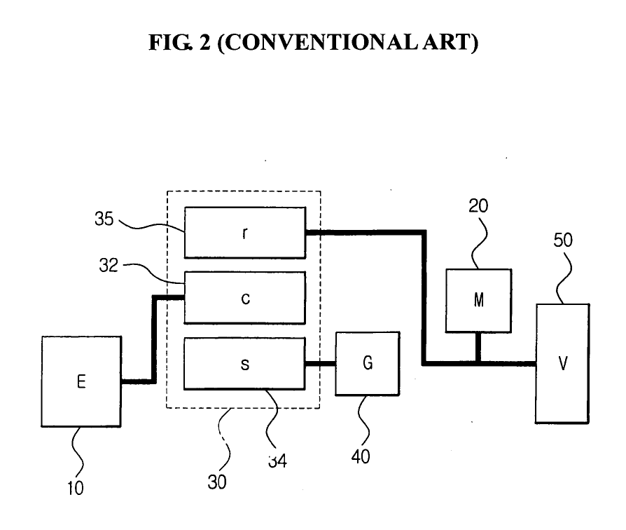

FIG. 3 is a diagrammatic view illustrating a power transmission apparatus for a hybrid vehicle according to an embodiment of the present invention;

FIG. 4 is a diagrammatic view illustrating the power transmission apparatus of FIG. 3, which is operating in a motor mode;

FIG. 5 is a diagrammatic view illustrating the power transmission apparatus of FIG. 3, which is operating in a hybrid mode;

FIG. 6 is a diagrammatic view illustrating the power transmission apparatus of FIG. 3, which is operating in an engine mode;

FIG. 7 is a diagrammatic view illustrating the power transmission apparatus of FIG. 3, which is operating in a regenerating braking mode; and

FIG. 8 is a graph showing the efficiency of the power transmission apparatuses according to the speed reduction ratio.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

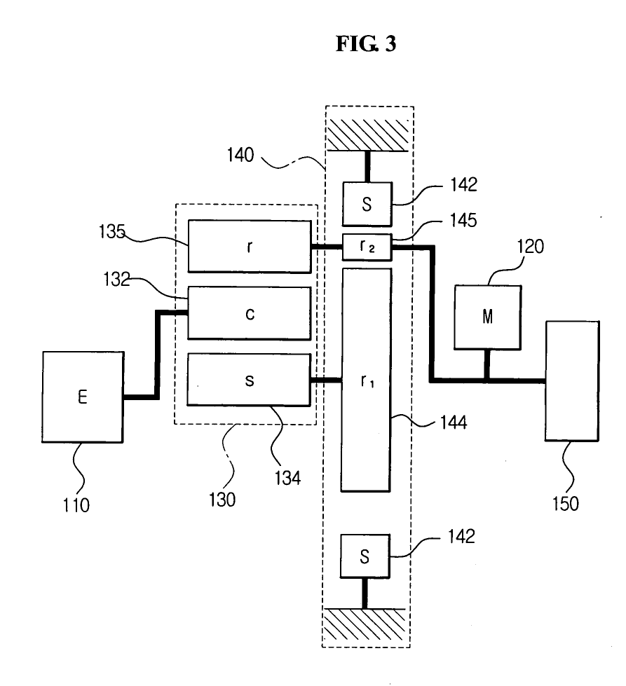

FIG. 3 is a diagrammatic view illustrating a power transmission apparatus for a hybrid vehicle according to an embodiment of the present invention;

Referring to FIG. 3, a power transmission apparatus comprises a first driving part and a second driving part. According to the present embodiment, an engine 110 is provided as the first driving part and a motor 120 is provided as the second driving part. The power transmission apparatus of the present embodiment further comprises a power splitting part and a generator. The generator can convert mechanical energy transmitted through the power splitting part into electric energy when operating, and can covert mechanical energy transmitted through at least one wheel of a hybrid vehicle into electric energy when braking or deceleration.

The power splitting part may employ a planetary gear system 130, and the energy generated by the engine 110 is split by the planetary gear system 130 and transmitted to the generator 140 and an output shaft of the output part. The generator 140 comprises an inner rotor 144, an outer rotor 145 and a stator 142. The inner rotor 144 is disposed at a center of the generator 140, the outer rotor 145 rotates along a circumference of the inner rotor 144. The output shaft in the present embodiment is operatively connected to at least one wheel 150 of the hybrid vehicle to work together. In detail, during transmission of the energy from the engine 110 to the wheels 150, a drive shaft of the engine 110 is operatively connected with planet gear 132 to rotate together with them, a sun gear 134 of the planetary gear system 130 rotates together with the inner rotor 144 of the generator 140, and a ring gear 135 of the planetary gear system 130 rotates together with the outer rotor 145 of the generator 140. The stator 142 is disposed around the outer rotor 145.

The outer rotor 145 can generate an alternating current using a portion of an energy transmitted from the ring gear 135. In this case, the generated alternating current may be storable in a state of electric energy and the other portion of the transmitted energy may go to the wheels 150 for driving the hybrid vehicle.

In addition, the motor 120 may serve as a driving part to drive the wheels 150 together with or independent from the engine 110. To drive the wheels 150, the motor 120 may use the energy stored in the battery or directly use the energy generated by the generator 140 without storage. In a hybrid mode, the motor 120 may drive the wheels 150 to help the engine 110, and in a motor mode, only the motor 120 may drive the wheels 150 using the energy stored in the battery 160.

In the present embodiment, power splitting is accomplished by the planetary gear system 130. The engine 110 can rotate the planet gear 132 of the planetary gear system 130, and the inner rotor 144 and the outer rotor 145 can rotate with the sun gear 134 and the ring gear 135 respectively. Accordingly, the output energy of the engine 110 is transmitted to the planet gear 132 and a portion of the output energy is transmitted to the generator 140 via the sun gear 134.

Also, when a torque of the generator 140 is applied to the ring gear 135, mechanical relationships between elements may be changed. In consideration of the mechanical relationships, a portion of the energy transmitted to the generator 140 transfers to the ring gear 135 because the torque of the generator 140 is applied to ring gear 135. As a result, an amount of the energy transmitted to the generator 140 may decrease. Since the efficiency of conversion from mechanical energy to electric energy is considerably low, reducing an amount of energy for the conversion will improve the efficiency of a hybrid transmission system.

The generator 140, the engine 110 and the motor 120 are operatively engaged with each other, and the angular velocities of them are also mutually restricted. The ratio of the angular velocities between the engine 110 and the motor 120 can be changed by control of the generator 140, and the angular velocity of the motor 120 is proportional to the speed of the hybrid vehicle. Accordingly, the planetary gear system 130 may be used not only as a power splitting device but also as a stepless transmission device.

The power transmission apparatus of the present embodiment can operate in a motor mode, an engine mode, a hybrid mode and a regenerative braking mode.

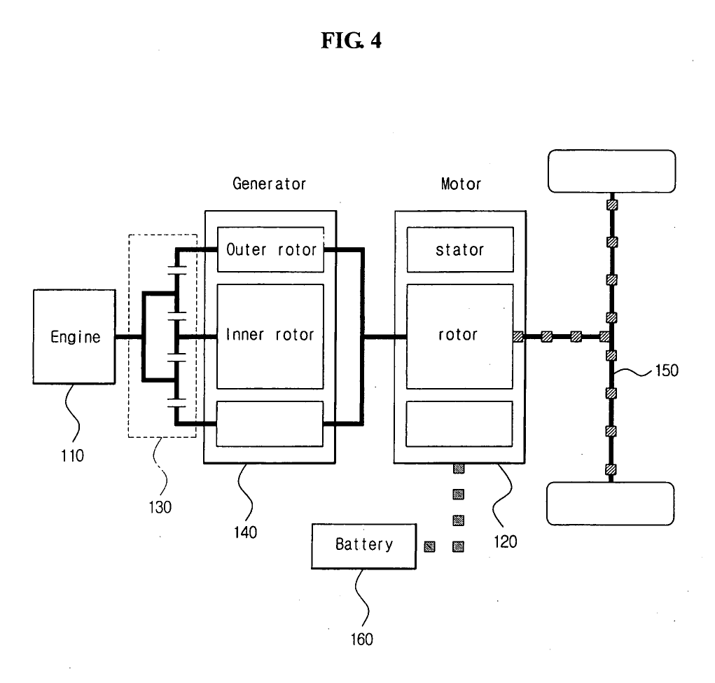

FIG. 4 is a diagrammatic view illustrating the power transmission apparatus of FIG. 3, which is operating in a motor mode.

Referring to FIG. 4, the motor 120 can drive the wheels 150 using the energy stored in the battery 160, in the motor mode. Since the ring gear 135 can rotate freely around the planet gear 132, the rotation of the motor 120 doesn't give influence on the engine 110. Actually, when the hybrid vehicle starts or moves slowly, it may operates in the motor mode and the motor 120 can drive the wheels 150 using the energy stored in the battery 160.

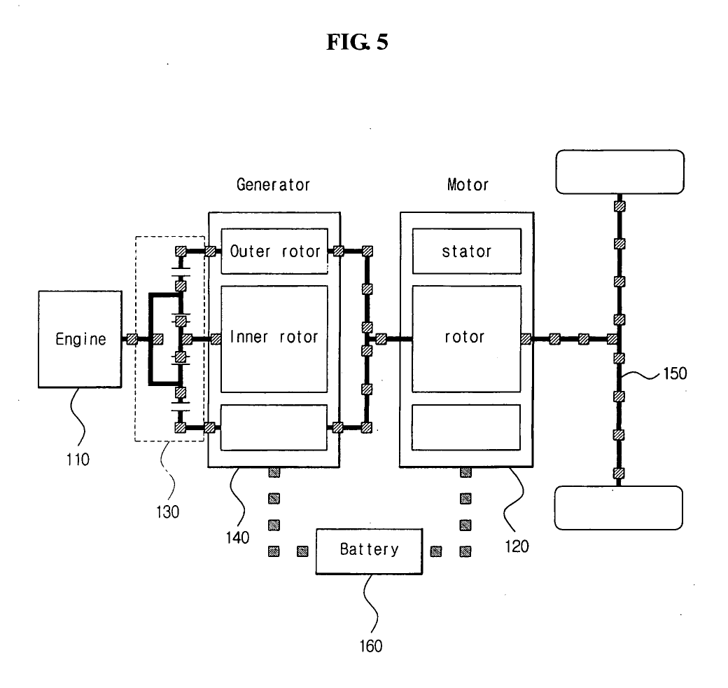

FIG. 5 is a diagrammatic view illustrating the power transmission apparatus of FIG. 3, which is operating in a hybrid mode.

Referring to FIG. 5, both the engine 110 and the motor 120 can drive the wheels 150 together. Actually, the hybrid vehicle may operate in a hybrid mode when driving under normal conditions, and the generator 140 may generate and supply electric energy to the motor 120 to help the engine 110 operate in a optimal state. In addition, a portion of the electric energy generated by the generator 140 may be stored in the battery 160 while the vehicle is traveling.

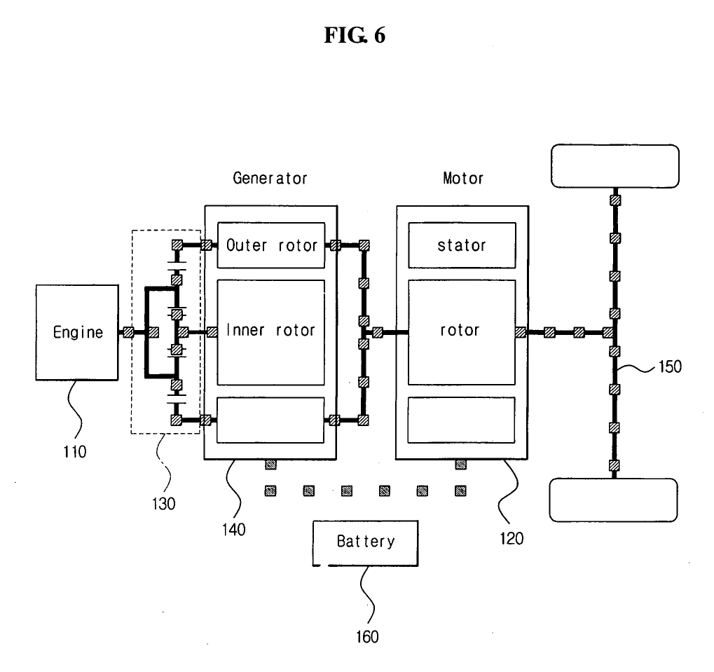

FIG. 6 is a diagrammatic view illustrating the power transmission apparatus of FIG. 3, which is operating in an engine mode.

Referring to FIG. 6, both the engine 110 and the motor 120 can also drive the wheels 150 together. The energy is transmitted from the engine 110 to the wheels 150 and the generator 140. A portion of the energy is directly transmitted to the wheels 150 and the other portion of the energy is indirectly transmitted to the wheels 150 via the generator 140 and the motor 120. However, the other portion of the energy transmitted via the generator 140 is fully transmitted to the motor 120 without storage. Actually, the hybrid vehicle may operate in an engine mode when a sudden acceleration is required, and all the energy generated by the generator 140 may be transmitted to the motor 120 and not stored in the battery 160, for use in a sudden acceleration.

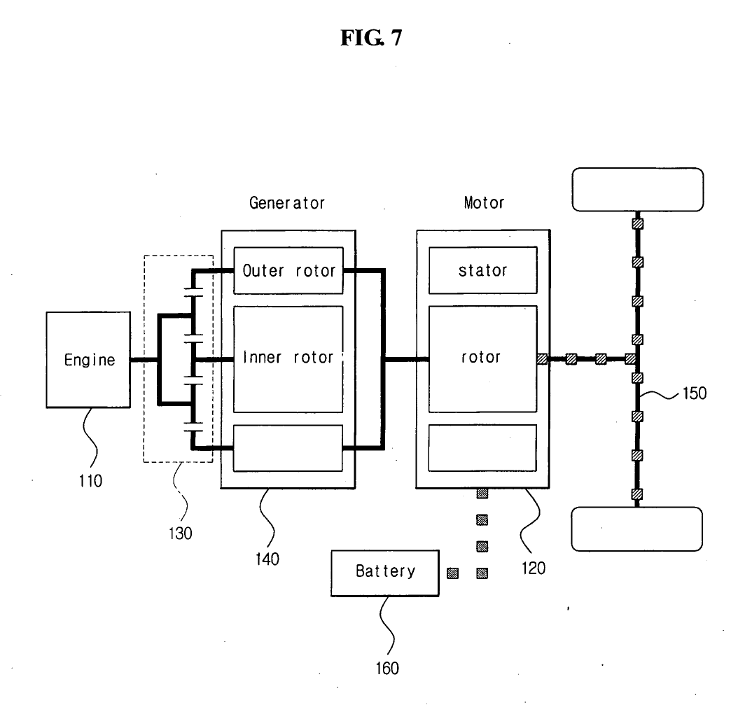

FIG. 7 is a diagrammatic view illustrating the power transmission apparatus of FIG. 3, which is operating in a regenerating braking mode.

Referring to FIG. 7, a portion of a kinetic energy of the hybrid vehicle may be stored in the battery 160 as a regenerative braking energy when the hybrid vehicle stops or decelerates. In this case, the motor may be used as a generator.

When the hybrid vehicle needs deceleration due to a red light of a signal light or going downhill, it may convert a portion of its kinetic energy into electric energy by the motor 120 and store the converted electric energy in the battery 160, instead of wasting its kinetic energy into the air in a state of heat energy.

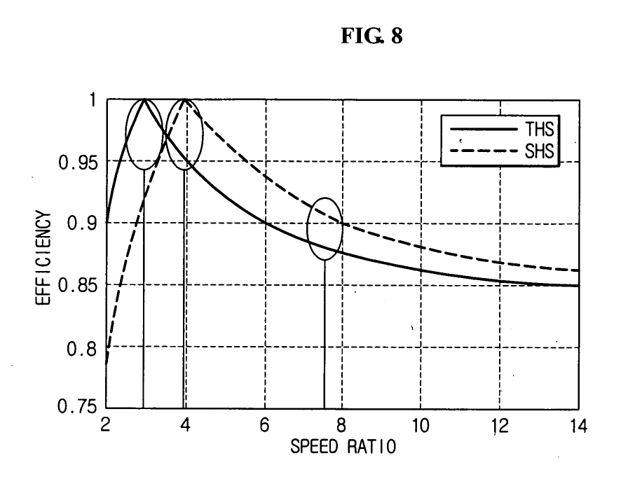

FIG. 8 is a graph showing the efficiency of the power transmission apparatuses according to the speed reduction ratio.

The efficiency of the power transmission apparatus according to the present invention may be given by Equation 1 and the efficiency of the conventional power transmission apparatus, such as THS (Toyota Hybrid System), may be given by Equation 2.

$$\begin{matrix}{η}_{system} = \frac{{P}_{out}}{{P}_{e}} = ( 1 - {η}_{m} {η}_{g} ) \frac{1}{SR} + {η}_{m} {η}_{g} & Equation 1 \\ {η}_{system} = \frac{{P}_{out}}{{P}_{e}} = ( 1 - {η}_{m} {η}_{g} ) \frac{R}{1 + R} \frac{1}{SR} + {η}_{m} {η}_{g} & Equation 2\end{matrix}$$

In the above equations, “η” represents the efficiency, “P” represents power, “R” represents the gear ratio of ring gear, and “SR” represents the ratio of the speed reduction.

As shown in the equations 1 and 2, the efficiency of the power transmission apparatus according to the present invention may increase because there is not an element of R/(1+R). As mentioned above, the relative angular velocity between the sun gear 134 and the ring gear 135 is decided as an angular velocity of the generator 140, such that an amount of the energy for conversion by the generator may be reduced relative to the conventional power transmission apparatus for the hybrid vehicle. Therefore, the hybrid vehicle according to the present invention can reduce the energy loss due to energy conversion and improve its efficiency.

Again referring to FIG. 8, the blue dotted line represents the efficiency of the present exemplary apparatus (SHS) according to one example of the present invention and the red solid line represents the efficiency of the conventional apparatus (THS). When SR (speed ratio) is low, around 2˜3, the efficiency of the conventional apparatus is higher than the present exemplary apparatus, however, the efficiency of the present exemplary apparatus is higher than that of the conventional apparatus on the whole.

The power transmission apparatus for a hybrid vehicle according to the present invention may reduce the loss of energy occurring in a conventional energy conversion procedure.

The power transmission apparatus for a hybrid vehicle according to the present invention may improve the efficiency of energy use by using a regenerative braking system which regenerates a portion of the energy expended when braking the vehicle.

The power transmission apparatus for a hybrid vehicle according to the present invention may reduce an amount of fuel required to operate the hybrid vehicle to help protect the environment.

What is claimed is:

1. A power transmission apparatus for a hybrid vehicle, comprising:
a first driving part;
a power splitting part for splitting an energy generated from the first driving part into branches of the energy;
an output part using one branch of the energy to drive at least one wheel of the hybrid vehicle;
a generator for converting each branch of the energy into a storable energy; and
a second driving part independently driving the output part using the storable energy generated by the generator.

2. The power transmission apparatus of claim 1, wherein the generator comprises a first converting section for converting another branch of the energy into one type of the storable energy and a second converting section for converting a portion of the one branch of the energy into another type of the storable energy.

3. The power transmission apparatus of claim 2, wherein the first and second converting sections generate each respective storable energy through mutual operations.

4. The power transmission apparatus of claim 1, further comprising a battery for storing an electric energy generated by the first and second converting sections, wherein the battery supplies the second driving part with the electric energy.

5. The power transmission apparatus of claim 4, wherein the second driving part is capable of regenerating an electric energy using the rotation of the at least one wheel and the regenerated electric energy is stored in the battery.

6. A power transmission apparatus for a hybrid vehicle, comprising:
an engine;
a power splitting part comprising a sun gear, a planet gear and a ring gear, the planet gear operatively connected with a drive shaft of the engine;
a generating part comprising an inner rotor operatively connected with the sun gear, an outer rotor operatively connected with the ring gear to rotate along the circumference of the inner rotor, and a stator disposed around the outer rotor; and
a motor comprising an output shaft operatively connected with the ring gear and the outer rotor.

7. The power transmission apparatus of claim 6, further comprising a battery for storing an electric energy generated by the inner and outer rotors, wherein the battery supplies the motor with the electric energy.

8. The power transmission apparatus of claim 7, wherein, the motor is capable of regenerating an electric energy by using the rotation of the at least one wheel and the regenerated electric energy is stored in the battery.
